(19) United States
(12) Patent Application Publication
(10) Pub. No.: US 2026/0369275 A1
(43) Pub. Date: Nov. 19, 2026

(54) SYSTEMS AND METHODS FOR CONVERTING MEDIA FILES INTO TEXT-BASED INSTRUCTIONS

(71) Applicant: Brennan Intellectual Holdings, LLC, Morristown, NJ (US)

(72) Inventor: Sean Joseph Brennan, Morristown, NJ (US)

(73) Assignee: Brennan Intellectual Holdings, LLC, Morristown, NJ (US)

(21) Appl. No.: 19/212,603

(22) Filed: May 19, 2025

(51) Int. Cl. G10L 15/26; G06F 16/955

(52) U.S. Cl. CPC G10L 15/26; G06F 16/955

(57) ABSTRACT

A computing system includes an application for converting media files into formatted text-based instructions. The computing system receives a web address of a webpage containing a media file via a user interface and transcribes audio data from the media file into formatted text-based instructions using artificial intelligence programming interfaces. The computing system stores the formatted text-based instructions in a digital catalog for users to access for viewing and modification via a graphical user interface.

### BACKGROUND OF THE INVENTION

The digital landscape has experienced a significant shift towards online platforms, with individuals increasingly turning to these resources for instructional content across various domains, such as cooking and exercise. Video and audio content have become popular mediums for sharing techniques and instructions, offering a dynamic and engaging way to learn new skills. However, while these formats provide rich, visual, and auditory experiences, they often lack the convenience and accessibility of traditional text-based instructions, which can be easily referenced and followed.

The growing demand for digital instructional content has highlighted the need for innovative solutions to bridge the gap between multimedia formats and text-based instructions.

### BRIEF SUMMARY OF THE INVENTION

In one aspect, a method of a computing system for converting at least one media file into text-based instructions, comprising: obtaining, using at least one graphical user interface (“GUI”) on a client device, the at least one media file; conducting, by the computing system, at least one error checkpoint; extracting, by the computing system, audio data from the at least one media file; transcribing, by the computing system, the audio data to a text-based transcript; generating, by the computing system, the text-based instructions using the text transcription; and storing, by the computing system, the text-based instructions in at least one memory device.

In another aspect, a computing system for converting at least one media file into text-based instructions, comprising: at least one network interface configured for communication over one or more networks; at least one memory device, wherein the at least one memory device stores retrievable text-based instructions; at least one processing device, wherein the at least one processing device is operatively coupled to the at least one memory device and wherein the at least one memory device stores instructions that, when executed by the at least one processing device, configures the computing system to: obtaining, using at least one graphical user interface (“GUI”) on a client device, the at least one media file; conducting, by the computing system, at least one error checkpoint; extracting, by the computing system, audio data from the at least one media file; transcribing, by the computing system, the audio data to a text-based transcript; generating, by the computing system, the text-based instructions using the text transcription; and storing, by the computing system, the text-based instructions in at least one memory device.

### BRIEF DESCRIPTION OF THE SEVERAL VIEWS OF DRAWINGS

FIG. 1 depicts a schematic block diagram of an exemplary computing system for converting media files to text-based instructions, in accordance with one or more embodiments herein.

FIG. 2 depicts a flow chart of an exemplary method showing the process of converting media files to text-based instructions, in accordance with one or more embodiments herein.

FIG. 3 depicts a flow chart of an exemplary method showing the process of converting media files into text-based instructions, including error checkpoints, in accordance with one or more embodiments herein.

FIG. 4 depicts a flow chart of an exemplary method showing the process of a Generative AI program generating text-based instructions from text-transcription data, in accordance with one or more embodiments herein.

FIG. 5A illustrates an exemplary embodiment of a graphical user interface on a client device for inputting a web address of a webpage containing audio data to be converted into text-based instructions, in accordance with one or more embodiments herein.

FIG. 5B illustrates an exemplary embodiment of another graphical user interface on a client device displaying the generated list of ingredients and equipment from the generated text-based instructions, in accordance with one or more embodiments herein.

FIG. 5C illustrates an exemplary embodiment of another graphical user interface on a client device displaying a generated organized cataloging system, in accordance with one or more embodiments herein.

FIG. 6 illustrates an exemplary embodiment of another graphical user interface on a client device displaying a search interface for stored text-based instructions, in accordance with one or more embodiments herein.

FIG. 7 depicts a schematic block diagram of an exemplary network environment including the computing system, in accordance with one or more embodiments herein.

FIG. 8 depicts a schematic block diagram of an exemplary computing device, in accordance with one or more embodiments herein.

FIG. 9 depicts a flow chart of an exemplary method showing the process of converting media files to text-based instructions, in accordance with one or more embodiments herein.

### DETAILED DESCRIPTION

The foregoing summary, as well as the following detailed description of preferred embodiments of the invention, will be better understood when read in conjunction with the appended drawings. To illustrate embodiments, there is shown in the drawings various examples and/or preferred embodiments. It should be understood, however, that the invention as claimed is not limited to the embodiments, examples, arrangements and instrumentalities shown in the drawings. The subject application references certain processes which are presented as series of ordered steps. The steps described with respect to these processes are not to be understood as enumerated consecutive lists but could be performed in various orders while still embodying the invention described herein.

The subject application references certain processes and methods which are presented as a series of ordered steps. The steps described with respect to these processes are not to be understood as enumerated consecutive lists but could be performed in various orders while still embodying the invention described herein. Additional and/or alternate steps may be included in such processes as well.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

### Overview

Users often find it challenging to extract and organize information from lengthy videos or audios, especially when they need to quickly reference specific steps or details. This has created a demand for tools that can efficiently convert multimedia instructional content, such as cooking and exercise videos, into structured, text-based formats. Additionally, there is a need for organized cataloging systems that allow for easy retrieval of these text-based instructions, enabling users to quickly access and manage their instructional content. The specification describes various embodiments of a computing system and conversion application that converts multimedia files including video and/or audio data (media files) into formatted text-based instructions. The computing system permits users to generate, save, and catalogue text-based instructions from any link of a webpage containing compatible media files. Users may select a specific webpage and input the web address, e.g., such as a Uniform Resource Locator (URL), into a graphical user interface (“GUI”) of the conversion program. The GUI may include, but is not limited to, web-based user interfaces or mobile applications. The computing system receives these links and determines if the media file is compatible with the computing system and contains audio and/or video data of instructions. When the media file includes compatible video data and/or audio data, the computing system downloads the media file and extracts the video and/or audio data. The audio data is then transcribed into text using voice recognition software, such as an Artificial Intelligent voice to text application accessed through an Application Programming Interface (“AI API”) for audio-to-text transcription (“Audio-to-Text Transcription AI API”). The transcribed text is then processed to generate structured text-based instructions using a Generative AI application. The Generative AI API is used to convert or reformat the text transcript as needed for processing by the Generative AI application. The formatted text-based instructions are stored in a database, allowing users to retrieve it through the GUI.

As such, this computing system and conversion application can provide a modern instructional book solution, enabling users to access and manage text-based instructions, like recipes or workout instructions, conveniently. The embodiments described herein bridge the gap between multimedia formats and text-based instructions. This approach allows users to enjoy the best of both worlds: the engaging nature of video and audio, combined with the practicality and ease of use of written instructions. As the digital instructional landscape continues to evolve, the embodiments herein provide solutions that enhance the accessibility, usability, and organization of online resources.

### Detailed Embodiments

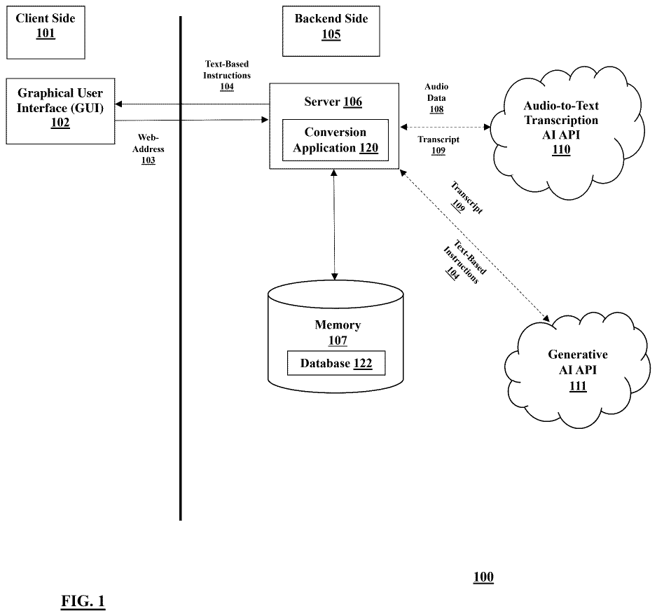

FIG. 1 depicts a schematic diagram of an exemplary computing system 100 for converting media files into text-based instructions 104 in accordance with one or more embodiments herein. The computing system 100 is divided into two main components: the client side 101 and the backend side 105. On the client side, a user device, such as user device 710a-b, receives HTML or other type of graphic files from the backend side 105 and generates one or more graphical user interfaces (GUIs) 102 using the files. The one or more GUIs include an input for a web address 103 of a webpage containing media files, which may include videos files 315 or audio files 314. For example, users may input a HyperText Transfer Protocol (“HTTP”) and/or a secure version (e.g., “https”) of a related Uniform Resource Locator (“URL”). The URL is a unique address that identifies a specific page or file of a website. Users may also access a database 122 and modify a catalog of text-based instructions 104 stored in the memory 107 via one or more GUIs 102. The one or more GUIs 102 may be generated and displayed by the user device 70a-b using a web-based platform or a mobile application, or other methods.

The backend side 105 features a conversion application server 106 including the Conversion Application 120 that processes the web address 103 of a webpage received from the client side 101 to download the associated media files. The conversion application server 106 is responsible for downloading audio data 108 from the media files of web pages of the web addresses 103, which is then sent to an Audio-to-Text Transcription AI API 110. The Audio-to-Text Transcription AI API 110 transcribes the audio data 108 into a text-based transcript 109. The text-based transcript 109 is subsequently formatted into text-based instructions 104 using a Generative AI API 111. These text-based instructions 104 are stored in the database 122 in the memory 107, ensuring that the text-based instructions are accessible for user retrieval and modification via the one or more GUIs 102.

The components of the computing system 100 interact to achieve the web address to text-based instruction conversion process. The conversion application server 106 coordinates the flow of data between the client side and the AI APIs. The Audio-to-Text Transcription AI API 110 converts audio data from the media files into text, while the Generative AI API 111 formats the text into coherent, user-friendly instructions. The memory 107 serves as a storage solution, saving the formatted and catalogued text-based instructions for future access and modification by users. This architecture supports the goal of providing a modern instruction book solution, allowing users to convert and manage their media files into structured text-based instructions.

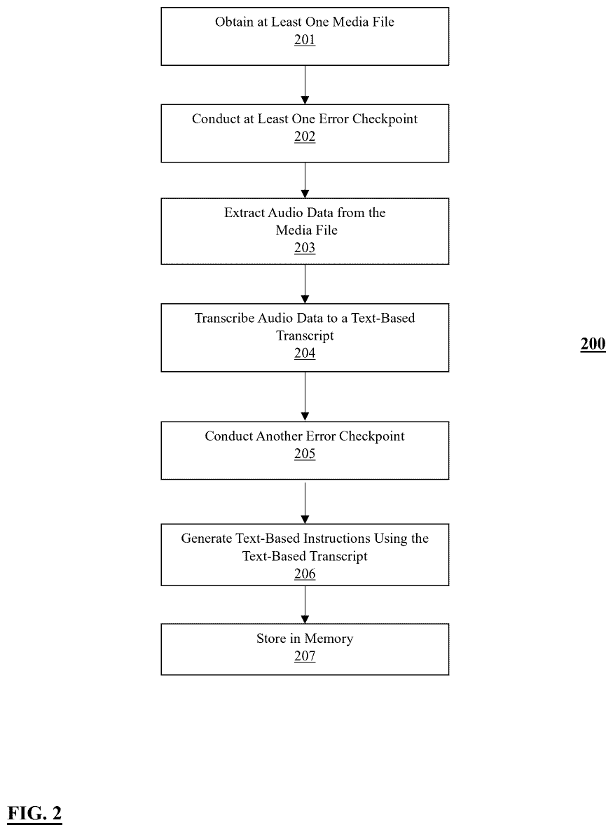

FIG. 2 depicts a flowchart detailing a method 200 of the computing system 100 for converting media files into text-based instructions 104. The process begins at 201, where at least one media file is obtained by the computing system 100. The computing system 100 attempts to access the web address 103 input into the one or more GUIs 102 and at 202, the computing system 100 conducts at least one error checkpoint, wherein the at least one error checkpoint may include, but is not limited to, a system check to determine whether the inputted web address 103 is a valid web address and/or whether the web address 103 is for a supported platform. At 203, when the web address 103 passes the at least one error checkpoint, the computing system 100 downloads one or more media files at the web address 103 and extracts the audio file or data 108 from the one or more media files. The media files may include audio files, such as MP3, WAV, AAC, or other types of audio files, and/or video files, such as MP4, MOV, WebM, or other type of video file, and/or image files, such as JPEG, PNG, GIF or other type of image files. At 204, the audio file or data 108 is sent to the Audio-to-Text Transcription AI API 110 to be processed by the Audio-to-Text Transcription AI application into the text-based transcript 109.

At 205, the computing system 100 may conduct another error checkpoint wherein the error checkpoint may include, but is not limited to, a system check to determine whether the text-based transcript 109 contains text describing instructions. When the text-based transcript 109 contains text describing instructions at 206, the text-based transcript 109 is sent to the Generative AI API 111 to be processed into formatted text-based instructions 104 by the Generative AI application 111. At 207, the text-based instructions 104 are saved in memory 107 for subsequent modification and retrieval by users, e.g., using the one or more GUIs 102. The text-based instructions 104 may be saved as text files, such as a .DOC file, .DOCX file, .pdf file, or other type of text file. The text files may be searchable by title, subject, keyword, content, etc.

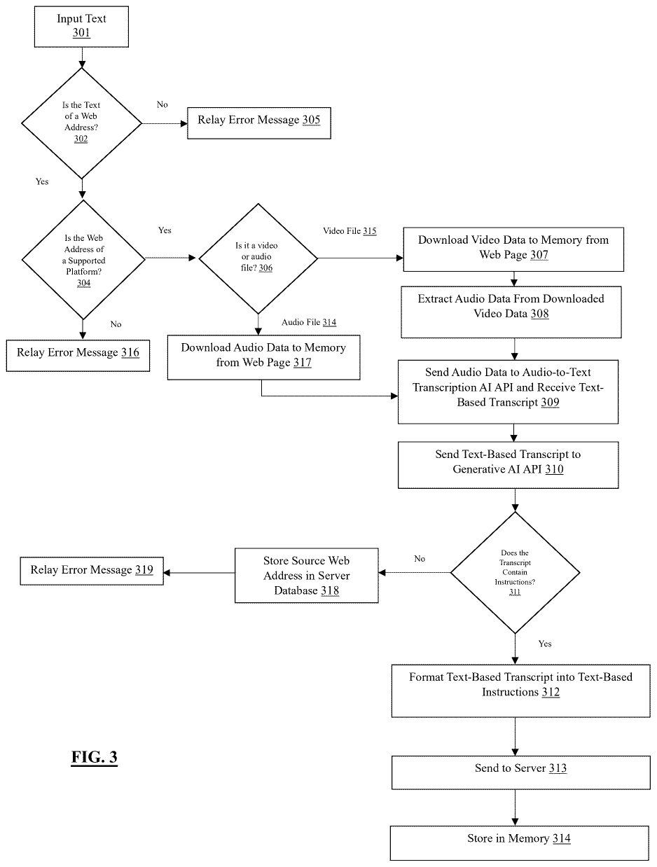

FIG. 3 illustrates a flowchart detailing a method 300 using the computing system 100 for converting media files into text-based instructions 104, including error checkpoints, in more detail. The process begins at 301, where a user inputs the text of a web address 103 via the one or more GUIs 102. At web address error checkpoint 302, the computing system 100 attempts to access the webpage and checks if the text represents a web address of a webpage containing a media file. If the text does not represent a web address of a webpage, the computing system 100 will relay an error message to the user at 305 and text is stored in the server 106 as incompatible with the computing system 100 to save time processing the same text if input again by a user. At platform error checkpoint 304, the computing system 100 checks if the provided web address is from a platform supported by the computing system 100 (e.g., YouTube® or TikTok®). If the web address is not from a supported platform, the computing system 100 will relay an error message to the user at 316 and the web address is stored in the server 106 as incompatible with the computing system 100 to save time processing the web address if input again by a user. If the web address is from a supported platform, the computing system 100 will proceed to 306, whereby the computing system 100 checks if the media file of the webpage includes an audio file 314 or video file 315 or other type of file at 306.

When it's determined at 306 that the media file is a video file 315, the video file 315 from the webpage of the web address 103 is downloaded to memory 107 at 307. At 308, audio data 108 and/or an audio file 314 is extracted from the downloaded video file 315. The extracted audio data 108/and or file 314 contains audio data of the instructions to be transcribed into formatted text-based instructions 104. When the media file is identified as an audio file 314 at 306, the audio data 108 and/or the audio file 314 is downloaded directly from the webpage to memory 107 at 317.

At 309, the extracted audio data 108/and or the audio file 314, e.g., from 308 or 317, is sent to the Audio-to-Text Transcription AI API 110, for processing by the Audio-to-Text Transcription AI application for the Audio-to-Text Transcription AI application to transcribe the audio data 108 of the audio file 314 into a text-based transcript 109. Though an AI application is described herein, other voice to text type applications may also be implemented.

The text-based transcript 109 is sent with processing instructions, via the server 106, to the Generative AI API 111 for processing by the Generative AI application at 310. The processing instructions sent to the Generative AI API include an instruction to conduct transcript error checkpoint 311, whereby the Generative AI application checks whether the text-based transcript contains instructions on how to do an activity (e.g., for recipes, does the transcript include language of a cook explaining how to prepare a dish, or instructions on how to do an exercise, or instructions on how to perform a repair, or instructions on how to do a craft, etc.) on how to perform a repair, or instructions on how to do a craft, etc.) at 311. If the text-based transcript 109 does not include instructions on how to do any activity, the web address 103 from which the text-based transcript 109 was obtained is stored in the server 106 at 318. This web address is identified in the server 106 as a web address that is incompatible with the computing system 100 to prevent a user from executing method 300 with the same incompatible web address, e.g., and thus, save time by the server 106 rechecking the web address and reperforming a text-based transcript 109. Upon the determination that the text-based transcript 109 does not include instructions at 311, the computing system 100 will subsequently relay an error message to the user at 319.

When the Generative AI application determines that the text-based transcript 109 contains instructions, the Generative AI application formats the text-based transcript 109 into text-based instructions 104 at 312. The Generative AI application formats the extracted text whereby the identified materials needed (e.g., garlic) are formatted into a list, including the quantity needed for each material (e.g., 1 garlic clove), and formats the identified instructions into an ordered and numbered list, thereby creating text-based instructions 104.

Other embodiments may also include the formatting of a list of equipment needed if the text-based instructions 104 disclose the need of such equipment (e.g., a pot or knife). For example, when the webpage includes an exercise video, the transcribed audio is formatted into a list of exercise equipment needed and a numbered list of moves and number of repetitions or times. In another example, when the webpage includes a craft project, the transcribed audio is formatted into a list of craft supplies and a numbered list of instructions to create the craft.

Once the text-based transcript 109 is formatted into text-based instructions 104, the text-based instructions are sent to the server 106 at 313 and stored in memory 107 at 314 so that the text-based instructions 104 are accessible for retrieval and modification by users through the one or more GUIs 102. The method 300 may thus be applied for use to generate text-based instructions 104 from audio data 108 containing instructions for recipes, exercise movements/routines, home repair, creating crafts, etc.

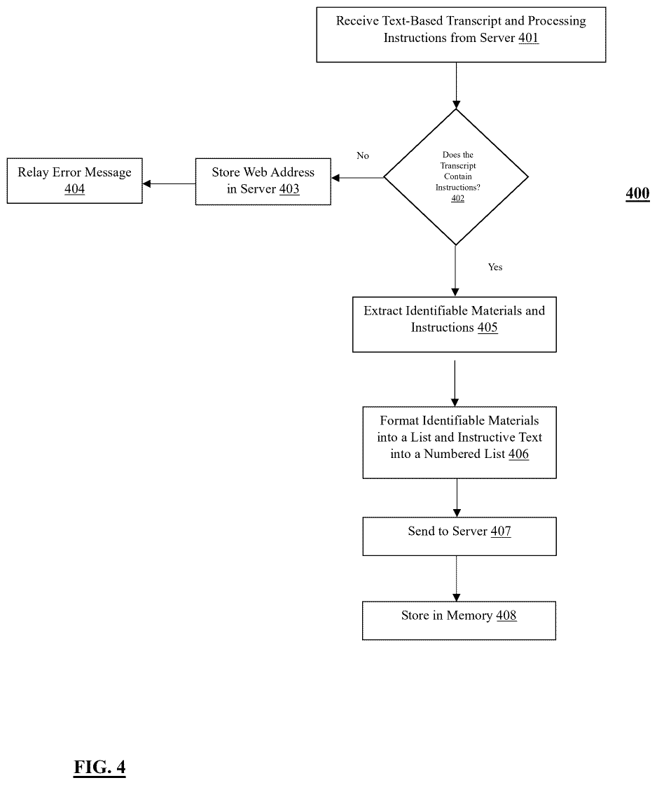

FIG. 4 depicts a flow chart of an exemplary method 400 whereby the Generative AI API 111 is used to convert or reformat the text-based transcript 109 into text-based instructions as needed for processing by the Generative AI application 111. The Generative AI application 111 receives the text-based transcript 109 and processing instructions from the server 100 at 401 via the Generative AI API 111. At 402, the Generative AI application, via the Generative AI API 111, checks whether the text-based transcript contains instructions on how to do an activity (e.g., for recipes, does the transcript include language of a cook explaining how to prepare a dish) at 402. If the text-based transcript 109 does not include instructions on how to do an activity, at 403, the web address 103 from which the text-based transcript 109 was obtained is stored in the server 106. This web address is identified in the server 106 as a web address that is incompatible with the computing system 100 to prevent a user from executing method 400 with the same incompatible web address. At 404, the computing system 100 relays an error message to the user upon the Generative AI application's determination that the text-based transcript 109 does not contain instructions. If the Generative AI application determines that the text-based transcript 109 contains instructions, the Generative AI application formats the text-based transcript 109 into text-based instructions 104.

At 405, the Generative AI application extracts text of identifiable materials (e.g., ingredients and/or equipment) and instructions. The Generative AI application formats the extracted text whereby the identifiable materials are formatted into a list, including the quantity needed for each material, and formats the instructions into an ordered/numbered list, thereby creating text-based instructions 104. Other embodiments may also include the formatting of a list of equipment needed if the text-based instructions 104 disclose the need of such equipment. Once the text-based transcript 109 is formatted into text-based instructions 104, the text-based instructions are sent to the server 106 at 407 and stored in memory 107 at 408 so that the text-based instructions 104 are accessible for retrieval and modification by users through the one or more GUIs 102.

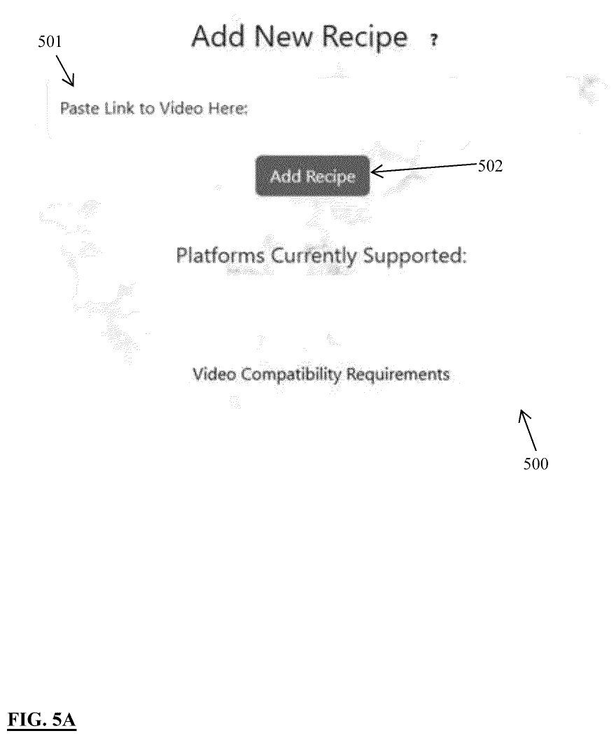

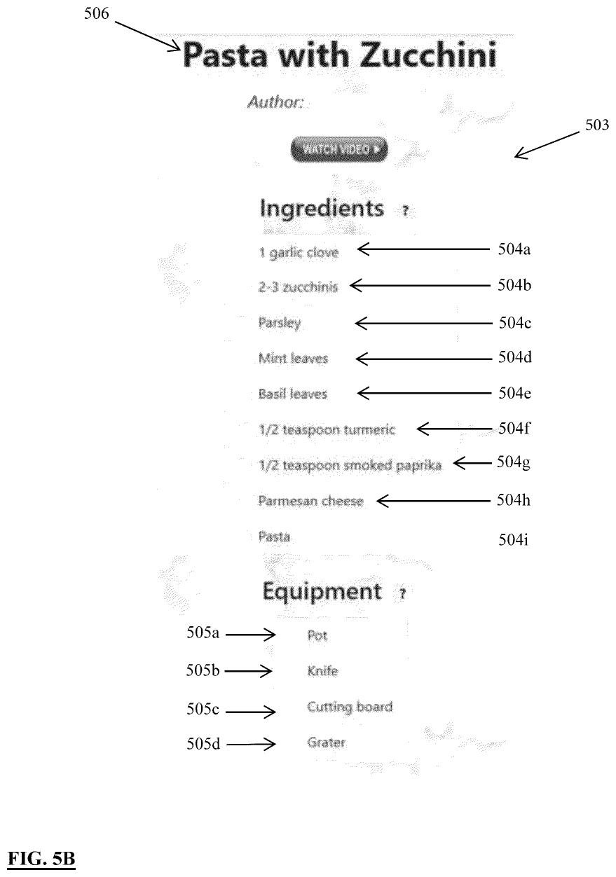

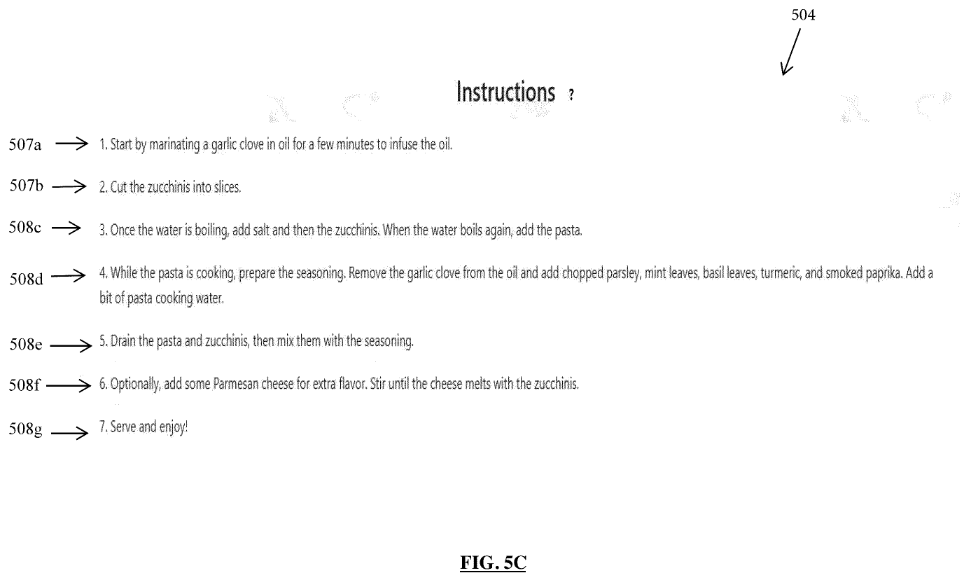

FIG. 5A illustrates an embodiment of an input interface 500 of the one or more GUIs 102. The input interface 500 is generated by a user device and displays an input interface bar 501 for inputting a web address 103. Users may insert, via the input interface bar 501, a web address 103 of a webpage containing a media file, such as the video file 315 or audio file 314. Although it is not depicted, in other embodiments, users may also directly upload a video file 315 or audio file 314, from the user device. Upon the insertion of a web address 103, users may instruct the conversion application 120 to generate text-based instructions 104 via a generation call-to-action (“CTA”) button 502, or any other user interface element wherein the user may instruct the conversion application 120 to proceed with the generation of text-based instructions 104.

FIG. 5B illustrates an embodiment of a results interface 503 of the GUI of a user device displaying the results of the generated text-based instructions 104, including a display of a list of ingredients 504a-i and list of equipment 505a-d of the generated text-based instructions 104 for the purposes of recipe generation. The results interface 503 displays the title 506 of the text-based instructions 104.

FIG. 5C illustrates an embodiment of an instruction results interface 504 displaying the instruction results of the generated text-based instructions 104 including a display of the list of numbered and ordered instructions 507a-g for the purposes of recipe generation.

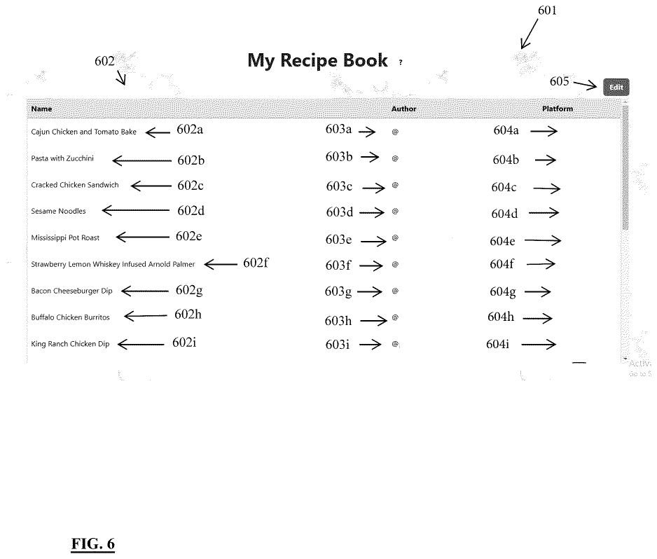

FIG. 6 illustrates an embodiment of a catalog interface 601 of the GUI of a user device whereby users may search for stored text-based instructions 104. The search interface 601 may include a listing 602 of text-based instructions 602a-i. Each text-based instruction 602a-i may also indicate the originating author 603a-i of each text-based instruction 602a-1, as well as the platform 604a-i from which the text-based instructions 602a-i were extracted from. Users may modify each text-based instruction 602a-i upon the selection of the edit CTA button 605.

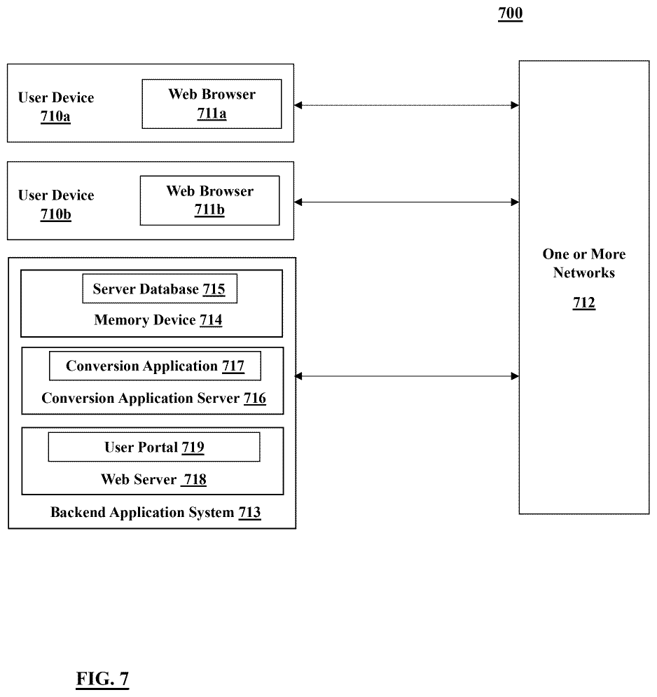

FIG. 7 depicts a schematic block diagram of an exemplary network environment 700 for implementing a computing system 100 that supports a recipe conversion application 717 in accordance with one or more embodiments herein. The network environment 700 includes a plurality of user devices 710a-b that are configured to communicate with the computing system 100. The user devices 710a-b may include computing devices, such as personal computers (“PCs”), server computers, handheld or laptop devices, cell phones, smartphones, tablets, minicomputers, or other devices including at least one processing device and at least one memory device. The user devices 710a-b may also have input device(s) and output devices such as keyboard, mouse, pen, mouse, voice input device, touch input device, a display, speakers, LED light, etc. In an embodiment, one or more of the user devices 710a-b are web-enabled devices configured with a web browser 711a-b to communicate with a web server 718 of the computing system 100. Additionally, and/or alternatively, one or more of the user devices 710a-b include a conversion application 717 that communicates using an application program interface (API) with the conversion application server 716 of the computing system 100.

In an embodiment, the web server 718 hosts one or more web portals, such as a user portal 719. The web portals are web-based platforms that provide graphical interfaces for and access to the functionality and services of the conversion application 717 and computing system 100 as well as access to data in all or portions of one or more of the databases of the computing system 100. The user portal 719 is configured to interact with the one or more web browsers 711a-b on the user devices 710a-b via an HTTP and/or a secure version (e.g., “https”) of a related URL. A conversion application server 716 may be accessible by the web server 718 to help respond to the web browsers 711a-b, using the publicly addressable URL. The conversion application server 716 may provide a software as a service (Saas) type offering for the conversion application 717. The web server 718 may include a network interface card (NIC) that includes one or more transceivers for wireless and/or wired network communications over the one or more networks 712. The NIC may also include authentication capability that requires an authentication process prior to allowing access to one or more of the web portals. For example, the authentication may include a login with a username and password, biometric identification, or other processes. The NIC may also include firewall, gateway, and proxy server functions.

In another embodiment, APIs on the conversion application 717 communicate directly with the user devices 10a-b in a client/server type architecture. The conversion application server 716 may include a NIC to communicate with the one or more networks 712 directly. Alternate methods of computing device/server communications may be substituted without departing from the scope hereof. Though a single web server 718 and conversion application server 716 are illustrated, multiple web and/or application servers may be implemented to perform the functions described herein.

The computing system 100 may further include at least one memory device 714 that stores one or more databases, such as a server database 715 containing formatted text-based instructions 104. The memory device 714 may include a server or other device including RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, cloud devices, or any other medium which can be used to store the desired information and which can be accessed by the conversion application server 716. The one or more networks 712 may include, e.g., a wide area network (WAN) and/or a wireless wide area network (Wireless WAN). For example, the WAN may include the Internet, service provider network, satellite WAN, or a combination of one or more thereof. The Wireless WAN may include a cellular network, such as a 4G or 5G cellular network. The WAN or Wireless WAN are communicatively coupled directly to the user devices 710a-b or coupled to the devices through an edge network and/or local area network (LAN), e.g., including a router, bridge, cable network, and/or a WLAN access point (AP) or another type of network or devices. The one or more networks 712 work to communicatively couple the user devices 710a-b to the computing system 100. Alternate networks and/or methods of communicating information may be substituted without departing from the scope hereof.

The exemplary network environment 700 provides a technical solution to the technical problem of conversion of audio data to readable text-based instructions for easy and efficient retrieval and cataloging by users. The network environment 700 depicts special purpose computing systems and devices that perform various functions and methods described herein. The depicted network environment 300 is only one example of a suitable computing environment and is not intended to suggest any limitation as to the scope of use or functionality. Numerous other special purpose computing system environments or other configurations may be used. Though shown separately, the databases may be included in one or more of their respective servers. The devices, servers and databases shown in FIG. 7 are merely exemplary and one or more of the devices, servers and/or databases may be omitted or added or combined without departing from the scope of the present invention.

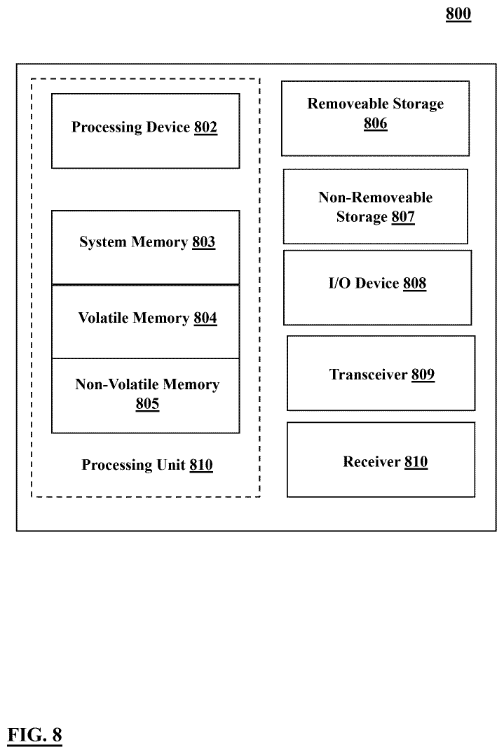

FIG. 8 depicts a schematic block diagram of an exemplary computing device 800 in accordance with one or more embodiments herein. The computing device 800 shows a basic configuration of the user devices 710a-b, web server 718, and conversion application server 716. The computing device 800 includes a processing unit 810 having at least one processing device 802 and at least one system memory 803. Depending on the exact configuration and type of the computing device, system memory 803 may include volatile memory 804 (such as random access memory (“RAM”)), non-volatile memory 805 (such as read-only memory (“ROM”), flash memory, etc.), or some combination of the two. Computing device 800 may may include additional storage, such as removable storage 806 or non-removable storage 807, including, but not limited to, magnetic or optical disks or tape, thumb drives, and external hard drives, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium or any other available storage media that can be accessed by computing device 800. The system memory 803 and/or the removable storage 406 and/or non-removable storage 807 includes computer-readable instructions, data structures, program modules, application-program interfaces (“APIs”), etc. that when executed by the processing device 02, causes the computing device 4080 to perform one or more functions described herein. Generally, program modules include routines, programs, objects, components, data structures, etc. that perform tasks or implement particular abstract data types. Such programs may be implemented in a high-level procedural or object-oriented programming language to communicate with the computer device 800. However, the program(s) can be implemented in assembly or machine language, if desired. In any case, the language may be a compiled or interpreted language and combined with hardware implementations.

The computing device 800 further includes at least one input/output (I/O) device 808, such as a display or touch screen, touch pad, keyboard, printer, speaker, mouse, etc. The computing device 800 may also include one or more transceivers 809, such as a wireless or wired transceiver, that allows the computing device 800 to communicate with other devices over one or more networks. Such one or more transceivers include computer-readable instructions, data structures, program modules and/or other data, to transmit a modulated data signal such as a carrier wave or other transport mechanism and includes any information delivery media. By way of example, and not limitation, communication media includes wired media such as a wired network or direct-wired connection, and wireless media such as acoustic, radio frequency (“RF”), infrared and other wireless media. In addition to that described herein, computing device 800 can be any web-enabled handheld device (e.g., cell phone, smart phone, or the like) or personal computer including those operating via Android™, Apple®, and/or Windows® mobile or non-mobile operating systems. The computing device 800 further includes one or more receivers 810, such as a wireless receiver or wired receiver, that allows the computing device 800 to communicate with other devices over one or more networks. The one or more receivers 810 may be any receiver compatible with the other components of the computing device 800.

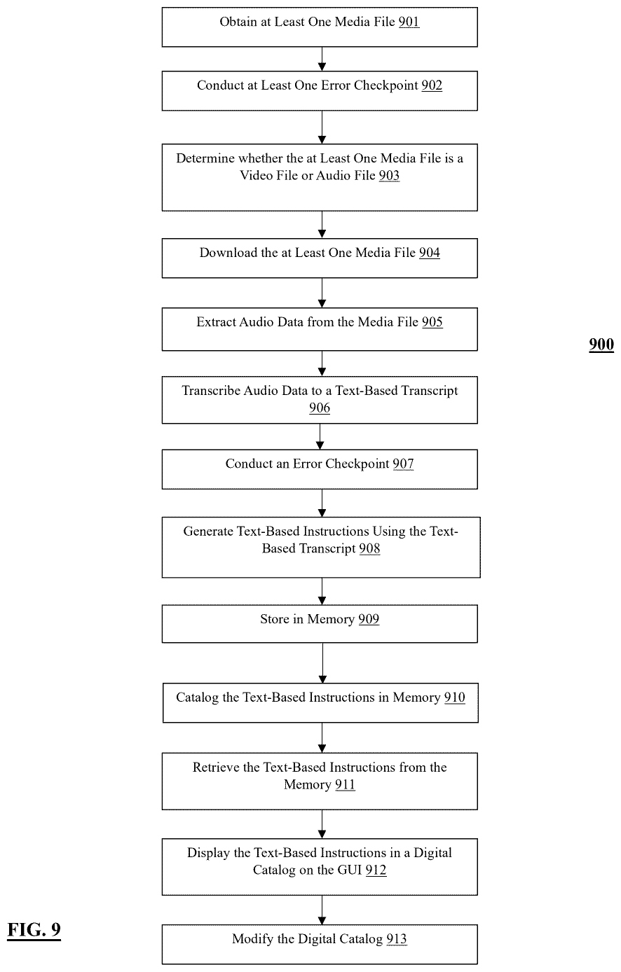

FIG. 9 depicts a flowchart detailing a method 900 of the computing system 100 for converting media files into text-based instructions 104 in more detail. The process begins at 901, where at least one media file is obtained by the computing system 100. At 902, the computing system 100 conducts at least one error checkpoint, wherein the at least one error checkpoint may include, but is not limited to, a system check to determine whether the text input into the GUI from which text-based instructions are to be generated from is text of a web address and/or whether the web address is of a supported platform. At 903, the computing system 100 determines whether the at least one media file is a video file or an audio file. At 904, the computing system 100 downloads the at least one media file and at 905, the computing system 100 extracts the audio data 108 from the media file to be transcribed into a text-based transcript 109. At 906, the audio data 108 is sent to the Audio-to-Text Transcription AI API 111 to be transcribed by the Audio-to-Text Transcription AI application into the text-based transcript 109. At 907, the computing system 100 may conduct another error checkpoint wherein the error checkpoint may include, but is not limited to, a system check to determine whether the text-based transcript 109 contains text describing instructions. At 908, the text-based transcript 109 is sent to the Generative AI API 111 to generate formatted text-based instructions 104 by the processing of the text-based transcript 109 by the Generative AI application. At 909, the text-based instructions 104 are saved in memory 107 and are cataloged in the memory 107 at 910 for subsequent modification and retrieval by users. Upon the selection of a user via the GUI, the computing system 100 retrieves the text-based instructions 104 from the memory 107 at 911, which is displayed via the GUI in a digital catalog at 912. At 913, upon the command of a user via the GUI, the computing system 100 may modify the digital catalog.

In the one or more embodiments described herein, the computing system 100 enables users to convert digital data into formatted text-based instructions (e.g., recipes) for easier and more efficient viewing and cataloging. This computing system may be used for audio or video files verbalizing instructions for recipes or exercises, or other activities disclosing instructions, so that users may be able to reference such instructions in a more organized manners without having to deal with the cumbersome process of having to pause the audio or video to write down the instructions. Instead, users can avoid the pen and paper and instead process the digital data for automatic transcription and formatting.

These benefits, advantages and solutions to problems described herein with regard to one or more embodiments are merely exemplary and are not required or exclusive. Any benefit, advantage, solution to a problem, or any element that may cause any particular benefit, advantage, or solution to occur or to become more pronounced are not to be construed as critical, required, or essential features or components of any or all embodiments in the claims.

Although several processes have been disclosed herein as software, it may be appreciated by one of skill in the art that the same processes, functions, etc. may be performed via hardware or a combination of hardware and software. Similarly, although the present embodiments may have been depicted as a hardwired system, these concepts may be applied to wireless systems and hybrid hardwired and wireless systems without departing from the scope of the present invention.

Some embodiments are described herein as a process that is depicted as a schematic, a flowchart, a flow diagram, a structure diagram, or a block diagram. Although a flowchart may describe the operations as a sequential process, the operations may be performed in parallel or concurrently. In addition, the order of the steps or operations may be re-arranged, and steps or operations may be combined or additional and/or alternate steps included. The described methods or process may correspond to a method, a function, a procedure, a subroutine, a subprogram, etc.

Reference to an element in the singular is not intended to mean “one and only one” unless specifically so stated, but rather “one or more.” As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of a computing system for converting at least one media file into text-based instructions, comprising:
obtaining, using at least one graphical user interface (“GUI”) on a client device, the at least one media file;
conducting, by the computing system, at least one error checkpoint;
extracting, by the computing system, audio data from the at least one media file;
transcribing, by the computing system, the audio data to a text-based transcript;
generating, by the computing system, the text-based instructions using the text transcription; and
storing, by the computing system, the text-based instructions in at least one memory device.

2. The method of claim 1, wherein obtaining, using the at least one GUI on the client device, the at least one media file, comprises:
obtaining from the client device a web address of a web page;
accessing the web address of the web page; and
downloading the at least one media from the web address of the web page.

3. The method of claim 2, wherein conducting the at least one error checkpoint includes:
determining whether the text-based transcript contains instructions;
when the text-based transcript does not contain instructions, storing the web address in the at least one memory device as an incompatible web address; and
indicating that the web address of the web page is incompatible via the at least one GUI.

4. The method of claim 1, further comprising:
determining, by the computing system, whether the at least one media file is an audio file or a video file.

5. The method of claim 1, further comprising:
downloading, by the computing system, the at least one media file.

6. The method of claim 1, further comprising:
cataloging, by the computing system, the text-based instructions in at least one digital catalog of the at least one memory device.

7. The method of claim 6, further comprising:
retrieving, by the computing system, the text-based instructions from the at least one digital catalog of the at least one memory device.

8. The method of claim 7, further comprising:
displaying, via the GUI of the computing system, the text-based instructions in the at least one digital catalog.

9. The method of claim 8, further comprising:
modifying, by the computing system, the at least one digital catalog.

10. The method of claim 1, wherein the at least one GUI is a web-based user interface or a mobile application.

11. The method of claim 3, wherein the at least one media file is an audio file and/or a video file

12. A computing system for converting at least one media file into text-based instructions, comprising:
at least one network interface configured for communication over one or more networks;
at least one memory device, wherein the at least one memory device stores retrievable text-based instructions;
at least one processing device, wherein the at least one processing device is operatively coupled to the at least one memory device and wherein the at least one memory device stores instructions that, when executed by the at least one processing device, configures the computing system to:
obtain, using at least one graphical user interface (“GUI”) on a client device, the at least one media file;
conduct, by the computing system, at least one error checkpoint;
extract, by the computing system, audio data from the at least one media file;
transcribe, by the computing system, the audio data to a text-based transcript;
generate, by the computing system, the text-based instructions using the text transcription; and
store, by the computing system, the text-based instructions in at least one memory device.

13. The computing system of claim 12, wherein the at least one media file is obtained from a web address of a web page.

14. The computing system of claim 13, wherein the computing system is configured to conduct the at least one error checkpoint by:
determining whether the text-based transcript contains instructions;
when the text-based transcript does not contain instructions, storing the web address as an incompatible web address; and
indicating that the web address of the web page is incompatible via the at least one GUI.

15. The computing system of claim 12, wherein the at least one processing device is further configured to:
determine whether the at least one media file is an audio file or a video file.

16. The computing system of claim 12, wherein the at least one processing device is further configured to:
download the at least one media file.

17. The computing system of claim 12, wherein the at least one processing device is further configured to:
catalog the text-based instructions in at least one digital catalog of the at least one memory device.

18. The computing system of claim 17, wherein the at least one processing device is further configured to:
retrieve the text-based instructions from the at least one digital catalog of the at least one memory device.

19. The computing system of claim 18, wherein the at least one processing device is further configured to:
display, via the GUI, the text-based instructions in the at least one digital catalog.

20. The computing system of claim 19, wherein the at least one processing device is further configured to:
modify the at least one digital catalog.

21. The computing system of claim 12, wherein the at least one GUI is a web-based user interface or a mobile application.

22. The computing system of claim 14, wherein the at least one media file is an audio file and/or a video file.

23. The computing system of claim 12, wherein the at least one processing device generates, using the generative artificial intelligence application, the text-based instructions from the text transcription by:
generating a list of a plurality of ingredients and/or equipment in a recipe; and
generating a list of steps of the recipe in order.

24. The computing system of claim 12, wherein the at least one processing device generates a digital modular cookbook including the recipe.
